(19) United States
(12) Patent Application Publication
(10) Pub. No.: US 2021/0049653 A1
(43) Pub. Date: Feb. 18, 2021

(54) Coupon Program Supporting Non-Profits, Merchants, and Individuals

(71) Applicants: Alexander S. Ewell, Modesto, CA (US); Andrea Dworshak-Ewell, Foresthill, CA (US); Timothy V. Ewell, Foresthill, CA (US)

(72) Inventors: Alexander S. Ewell, Modesto, CA (US); Andrea Dworshak-Ewell, Foresthill, CA (US); Timothy V. Ewell, Foresthill, CA (US)

(21) Appl. No.: 17/073,806

(22) Filed: Oct. 19, 2020

Related U.S. Application Data
(63) Continuation-in-part of application No. 15/944,580, filed on Apr. 3, 2018, now abandoned.
(60) Provisional application No. 62/480,767, filed on Apr. 3, 2017.

(51) Int. Cl. G06Q 30/02; G06Q 30/06; G06F 3/0482

(52) U.S. Cl. CPC G06Q 30/0279; G06Q 30/0213; G06F 3/0482; G06Q 30/0641; G06Q 30/0625; G06Q 30/0226

(57) ABSTRACT

Upon making a donation to a charitable organization, a consumer is awarded coupons or system points that may be used for percentage discounts toward the purchase of goods and services from enrolled or in-network merchants. The coupons or system points are reusable and thus may be reused by a merchant with other in-network merchants. A merchant may also freely transfer or gift the coupons or system points. The coupons or system points may be reused in an infinite number of transactions

### CROSS-REFERENCE TO RELATED APPLICATIONS

This utility patent application is a continuation in part of U.S. patent application Ser. No. 15/944,580 filed on Apr. 3, 2018 which claims the benefit and priority of U.S. patent application 62/480,767 filed on Apr. 3, 2017.

### BACKGROUND OF THE INVENTION

### (1) Field of the Invention

The invention generally relates to fund raising and discount coupon systems. More particularly, the invention relates to means and methods of creating an electronic server, database and other systems to facilitate a fund raising and merchant discount system interfacing with an integrated discount system. The invention further relates to means and methods of enabling a consumer to donate to a charity wherein the consumer receives a reusable coupon that may be used with an in-network merchant wherein the merchant may use the received reusable coupon

### (2) Description of the Related Art

The known related art fails to anticipate or disclose the principles of the present invention.

In the related art, generalized discount coupons are known.

In a somewhat related field, online donation systems are known.

The known related art fails to artfully combine consumer donation systems with merchant discount or coupon systems.

Thus, there is need in the art for the present invention.

### BRIEF SUMMARY OF THE INVENTION

The present invention overcomes shortfalls in the related art by presenting an unobvious and unique combination and configuration of methods and components to facilitate consumer donations via electronic and/or physical means that triggers a discount coupon to the relevant consumer. The consumer may then use the discount coupon with a system authorized merchant. The receiving merchant may then reuse the discount coupon within the authorized network of system participants.

Disclosed embodiments overcome shortfalls in the art wherein consumers make donations but receive little or no tangible assets in return. Disclosed embodiments overcome shortfalls in the art wherein merchants provided coupons, goods or services at a discount, and have no way to reuse the coupons they receive.

Disclosed embodiments may be described as follows:

In a first embodiment, a consumer makes a charitable contribution and receives a system or organization issued or approved reusable coupon. The coupon may be in integer denominations and may provide limited percentage discounts for goods and services and may have predetermined limits on total savings. For example, system coupons may be issued in five dollar increments wherein coupons are issued for 5, 10, 15 etc. dollars or some other selected increment. In a further example, a consumer may receive a 5-dollar coupon in response to making a 5 dollar donation to a charity. The consumer may give him a fifty percent discount on an item or service priced at 10 dollars or more.

In yet another variation, a consumer may receive coupons of a multiple of the money donated to a charitable cause. For example, a 5-dollar donation may return two five-dollar coupons.

The feature of predetermined limits on total savings may take the form of a system wide limit of x dollars for any transaction. For example, there could be system limitation of 50 dollars as the maximum savings amount. Under this scenario, with a 50 percent discount rate, a coupon holder would be limited to a 50 dollar discount on goods or services priced at 100 dollars or more. This example presumes that the user has coupons with a face value of 50 dollars or more. But, the disclosed embodiments include coupons having no cash value.

Thus, merchants who accept system coupons have a predefined limit of financial loss. The predetermined increments of system coupons also protects merchants from financial strain. For example, many items cost $9.99 wherein just one five-dollar coupon could be used, resulting in a price reduction of just $2.50. Thus, a merchant may receive a five-dollar reusable coupon at a cost of just $2.50 in a sale that was very close to 10 dollars. The merchant may then reuse or transfer the coupon to another person or merchant.

The merchants also profit from participation as coupon holders will gravitate to them by the merchant being listed in network registries which may take paper form or be posted upon the Web. Merchant business is also increased as coupon holders receive reasonable discounts with the merchant.

The dollar value of a coupon may sometimes be expressed as discount points, with each point having an assigned dollar value, such as one dollar. Disclosed embodiments include non-merchant specific coupons that are valid anywhere among all in network merchants.

In yet another embodiment a consumer database system issues applications or computer programs to consumer devices or provides a web based interface to allow consumers to create a consumer account.

A registered consumer may donate money to a registered or a participating non-profit organization. A separate non-profit database may be part of the overall system.

Upon executing a donation within the disclosed system, the registered consumer obtains points or other indicia of participation. Issued points may be exchanged for discounts with system registered merchants. A separate merchant database may be part of the overall system. System components may list or publish information regarding the registered merchants.

A registered consumer may tender or transfer points for a discount on a purchase (never an outright purchase) for goods or services from a registered merchant. Each transaction will generate a various transaction numbers and information. System components may include a separate transaction database. Transaction information may be available to registered merchants such that registered merchants may perform data analytics and otherwise track transactions and arising merchant point credit.

Registered merchants may collect points for discounts given and then reuse such points within the system. The reuse of points by merchants may follow the same protocol as points used by a consumer. Thus, a registered merchant obtains valuable consumer data and obtains points for reuse, with the necessity of making a donation.

Overall, disclosed embodiments help non-profits raise needed funds, help consumers save money in the purchase of goods and services and help merchants: 1. increase sales via controlled discounts; 2. Increase knowledge of consumer habits by review of past transaction information; 3. Save money by obtaining and reusing system discount points.

Disclosed embodiments overcome the prior art by presenting various user interfaces to allow various forms of communication between the various parties of the system. For example, a charity may register with the system and receive various donations on a one-time basis or monthly basis. The registered charity may send messages to the various subscribing consumers. Thus, the charity may increase public awareness of its cause. Subscribing consumers may send private or public messages or reviews to either subscribing charities and/or subscribing merchants.

The disclosed embodiments overcome shortfalls in the related art by allowing merchants to reuse points collected from consumers. Thus, a consumer may make a charitable donation, obtain points, use the points with a merchant. The merchant may then reuse the points with another merchant.

These and other objects and advantages will be made apparent when considering the following detailed specification when taken in conjunction with the drawings.

### BRIEF DESCRIPTION OF THE DRAWINGS

FIG. 1 depicts a schematic view of a disclosed system

FIG. 2 provides a flow chart of a disclosed process

FIG. 3 depicts a flow chart of disclosed systems and methods as executed with a personal electronic device

FIG. 4 depicts a starting interface for a consumer

FIG. 5 depicts an initial shopping interface

FIG. 6 depicts an initial list of organizations

FIG. 7 depicts an initial donation interface

FIG. 8 depicts a percentage of sharing interface

FIG. 9 depicts a search for businesses interface

FIG. 10 depicts a selection of a business

FIG. 11 depicts an interface displaying business attributes

FIG. 12 depicts a price calculation interface

FIG. 13 depicts a transaction total interface

FIG. 14 depicts a post-sale communication interface

FIG. 15 depicts the circulation of a reusable coupon

FIG. 16 depicts the system generation or tracking of coupon use

FIG. 17 depicts the reusable nature of the system coupons

FIG. 18 depicts a one-dollar donation being rewarded with two points

### REFERENCE NUMERALS IN THE DRAWINGS

100 a central server system
200 a plurality of databases
210 a database of non-profit organizations
220 a database of registered consumers
230 a database of registered merchants
240 a database of past transactions including consumer analytics
300 a representative consumer
400 a representative merchant
500 a disclosed process in general
510 account set up
520 credits or points transferred to consumer
530 points or discounts may be redeemed with a merchant
540 a merchant may view points redeemed at the merchant's store
550 a merchant may reuse points collected from consumers
600 general interface system
610 consumer home screen interface
620 initial shopping and point interface
630 initial charity selection interface
640 initial donation interface
650 percentage of donation interface
660 initial search for merchants interface
670 merchant drop down selection interface
675 merchant attribute interface
680 price and/or discount interface
685 competed transaction interface
690 post sale communication interface
700 a coupon circulation system
710 an individual making a donation
720 a donation
730 a non-profit charity
740 a coupon, sometimes called a ReQpon due to the reusable nature of a system coupon
750 the issuing of a coupon or discount points
800 an individual using a system coupon or ReQpon
810 the transfer of coupons or points to the merchant
820 the merchant granting a discount in exchange for the received points or coupons
900 a merchant in receipt of a coupon
910 a merchant reusing a coupon
920 a third recipient of a coupon which may be another merchant or other entity or person
1000 an individual purchasing or receiving a coupon or points multiplied from their donation

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

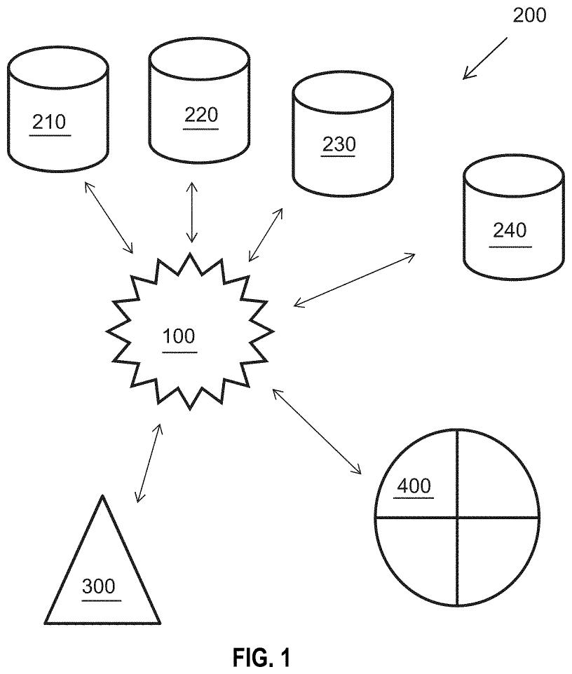

FIG. 1 depicts a contemplated computerized system using network systems, the Internet, mobile applications, web based interfaces and other machinery to facilitate a central server system 100 that is in communication with network systems and well as a plurality of databases 200, merchants 400 and consumers 300.

The plurality of databases 200 may include a database of non-profits 210, registered consumers 220, registered merchants 230 and past transactions 240 including consumer analytics.

Consumers may be in communication with the server system 100 to download a mobile application or to log on to a web based user interface. As consumers make donations they receive system points that may be exchanged for discounts with registered merchants 400. As transactions occur, transaction data is recorded in a database of past transactions 240.

Merchants 400 are uniquely positioned to review information upon the database of past transactions 240 in order to better understand consumer behavior and other consumer variables.

Moreover, merchants 400 enjoy the privilege of reusing collected coupons, thus giving extra incentives to attract merchants to become participating or registered merchants.

The disclosed embodiments include special purpose databases, special purpose processors and other improvements to the utilized computer hardware.

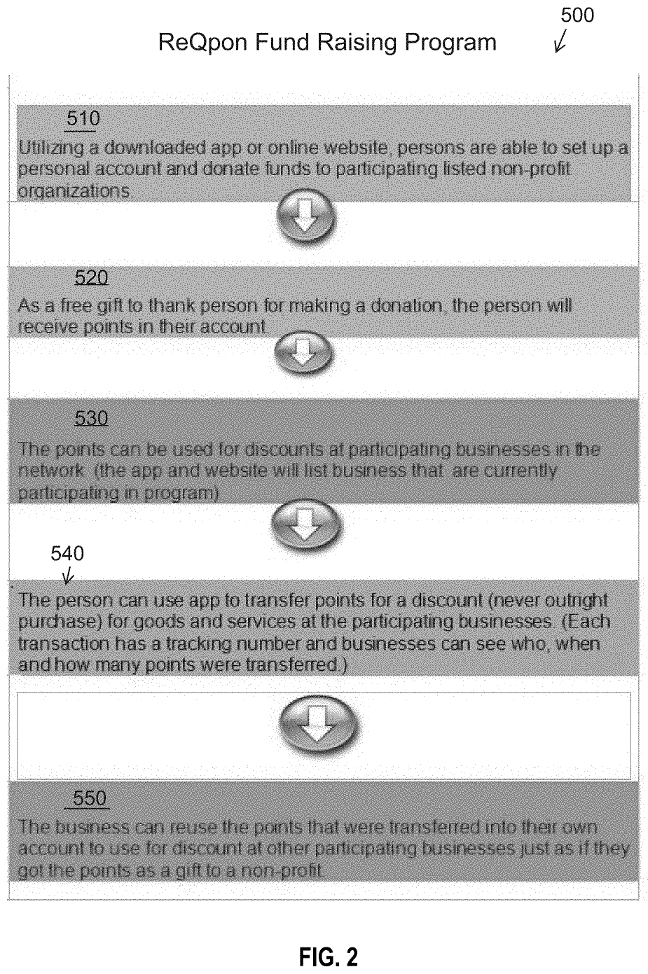

FIG. 2 depicts flow chart of a claimed embodiment. In one contemplated system or method, a user or consumer may download an application or computer program. The computer program may run upon the consumer's phone or other electronic device. Upon registration into a disclosed embodiment, a user may establish a personal account and donate funds to a participating non-profit or charitable organization.

A disclosed process 500 or system may include a first step 510 may include a consumer, charity or merchant creating a system account.

A second step 520 may include a consumer making a donation to a registered charity. After a donation is made, a system server or system database may transfer system points to the consumer's account.

A third step 530 may include a consumer redeeming or using points with a participating merchant. The consumer's points may be used for predetermined discount amounts or discount percentages.

A forth step 540 may include a reporting to a merchant of points redeemed at the merchant's store.

A fifth step 550 may include a merchant reusing points with another merchant.

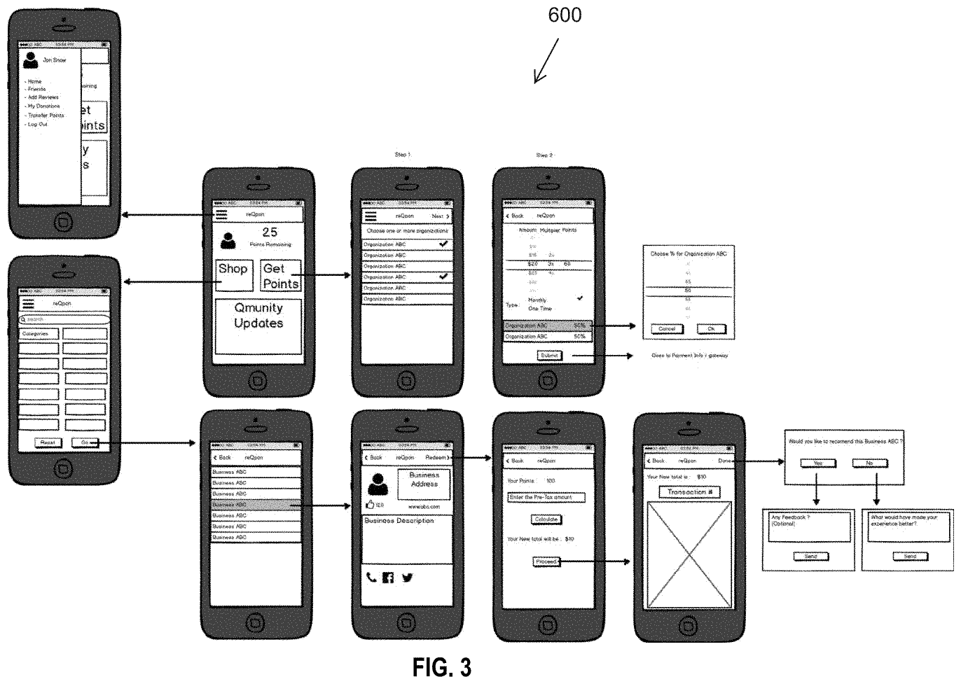

FIG. 3 depicts disclosed user interfaces and systems that implement the objectives of the invention within or upon a personal electronic device. The user interfaces are more completely shown in the drawings that follow.

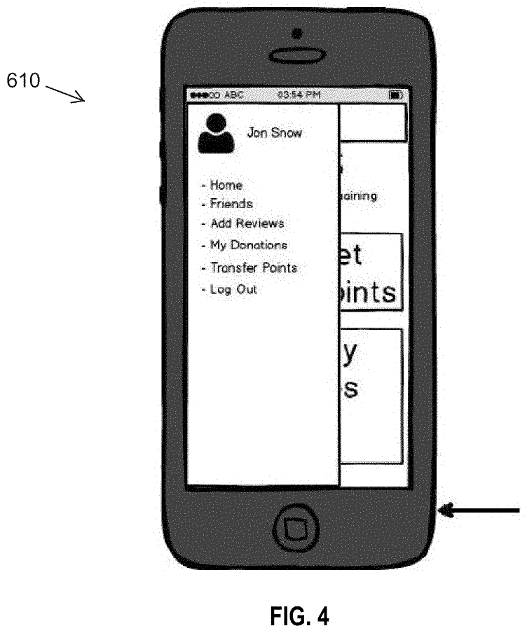

FIG. 4 depicts a starting interface 610 for a consumer. The interface may include hyperlinks or menus that include home, friends, add reviews, my donations, transfer points and log out. This starting interface may be imposed over a initial shopping interface shown in the next figure.

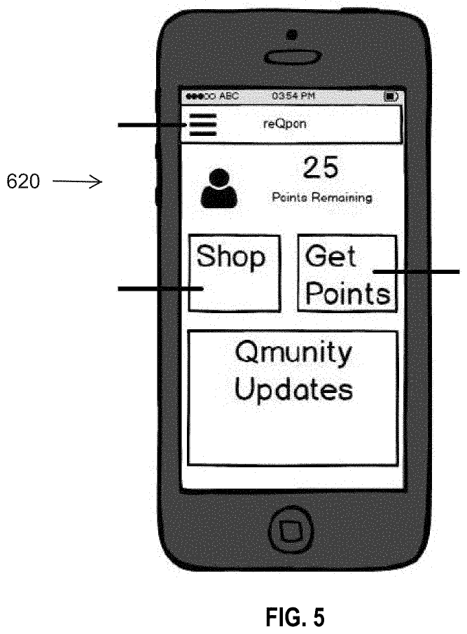

FIG. 5 depicts an initial shopping interface 620 that may include an icon or hyperlink area for shop, get points and community updates.

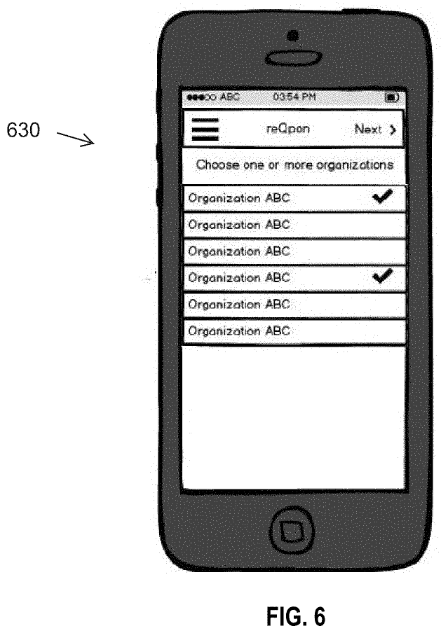

FIG. 6 depicts an initial charitable organization interface 630 that may display a plurality of charitable organizations that have joined the system. A user may select one or more charitable organizations by use of added indicia such as check marks next to the organizations.

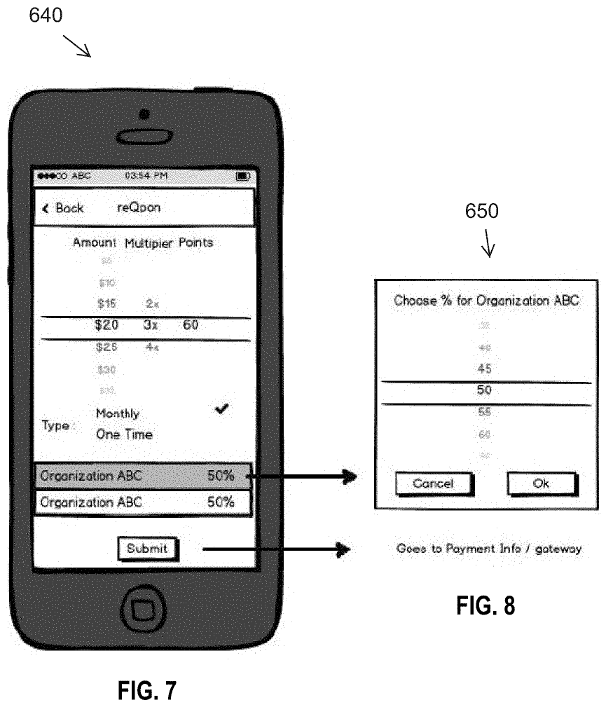

FIG. 7 depicts an initial donation interface 640 that may include a wheel or drop down selection menu for amounts to donate and multiplier properties or values for each donation. The use of interface multipliers overcomes shortfalls in the art by encouraging increasing donations to earn a greater point multiplier. System parameters for multiplier values may be adjusted to comport with market trends. The use of the multiplier interface may provide a number to multiple to derive the points awarded in response to a donation. The subject interface may also include a radio button or other indicia to offer or allow periodic donations.

FIG. 8 depicts a percentage of sharing interface 650 allowing a consumer to select the percentage of donation to be allocated to a selected charity. This interface and system overcomes shortfalls in the related art by encouraging consumers to derive one amount to donate on a one time or monthly basis. The total donation may then be shared with a plurality of charitable organizations as allocated by the consumer.

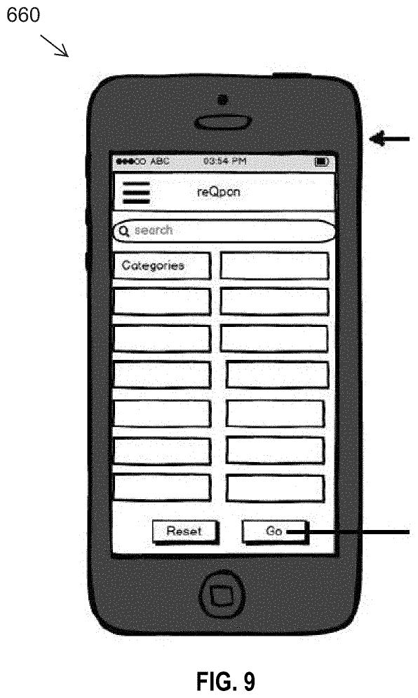

FIG. 9 depicts a search for merchants interface 660. The interface may include radio buttons and/or hyperlinks to categories of businesses as well has a search interface.

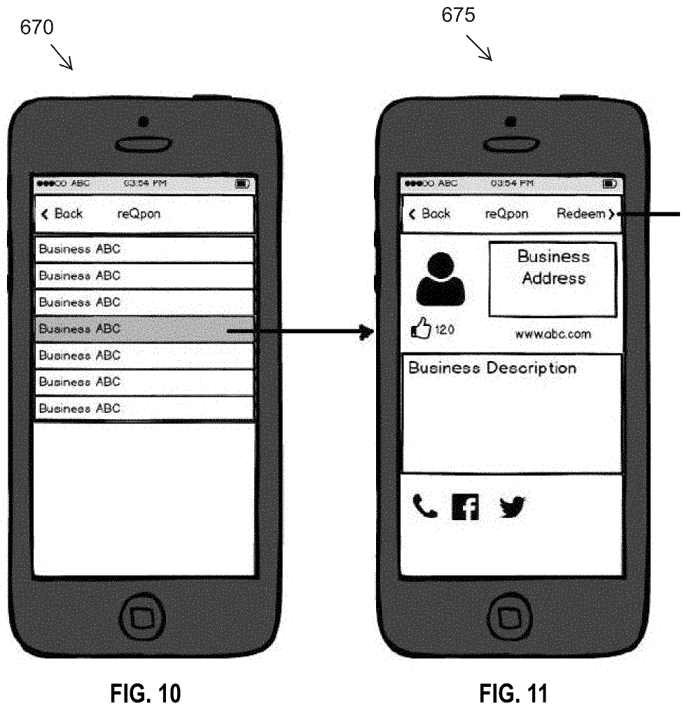

FIG. 10 depicts business or merchant listing interface 670 that may present a plurality of merchants comporting to the user input of the prior interface.

FIG. 11 depicts an interface of business attributes 675 which may include an upper display area or map for other system functions or displays such as back, coupon and redeem. The displayed business attributes may include name, address, link to website and a brief description.

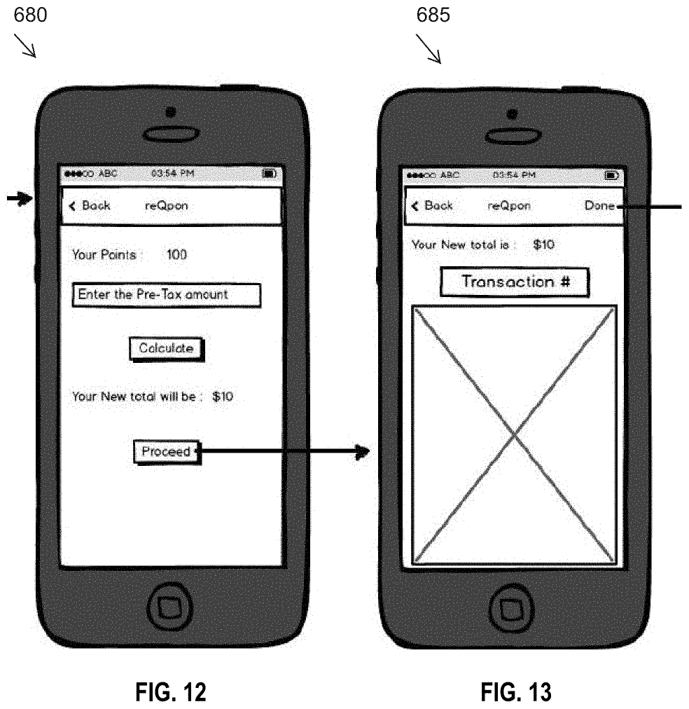

FIG. 12 depicts a price and/or discount interface 680 that may include an initial or undiscounted purchase price, consumer points available for use and a reduced cost window to reflect the discount given.

FIG. 13 depicts a transaction total interface 685 that may display the total cost to the consumer.

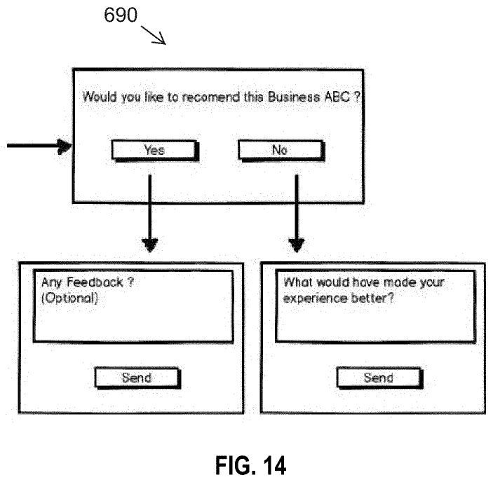

FIG. 14 depicts a post-sale communication interface 690 that includes interfaces for sending a public message regarding the subject merchant, a private message to the subject merchant or a rating for the subject merchant.

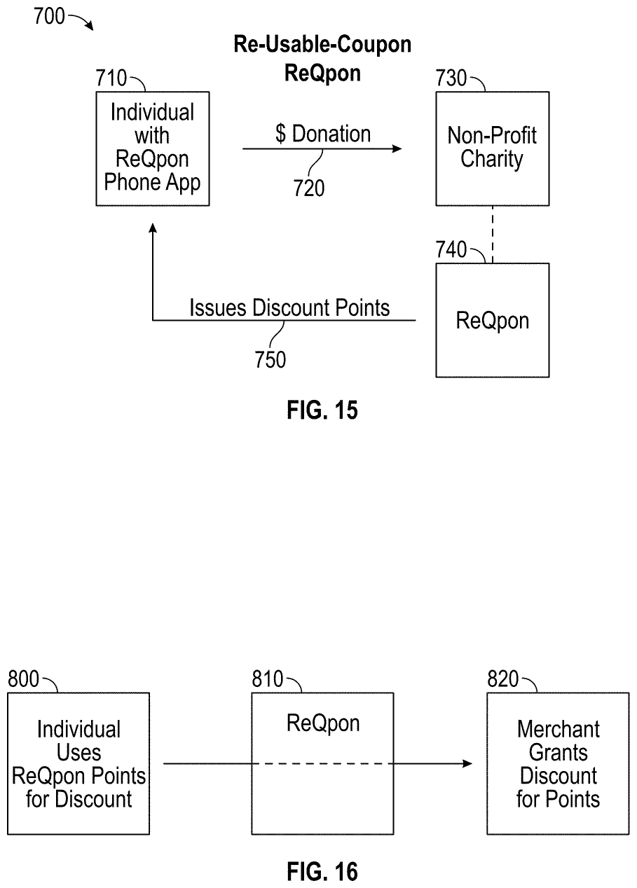

FIG. 15 depicts a coupon or reQpon recirculation system 700 wherein an individual 710 who may or may not have a ReQpon Phone App or other software assisting in the execution of a disclosed embodiment, makes a donation 720 to a non-profit charity 730 and wherein a coupon or ReQpon 740 takes one of many forms such as paper, electronic or other, with discount points 750 being issued to the individual 710.

FIG. 15 can also be viewed as an app based platform wherein an individual downloads an application or program for their smart phone or personal electronic device, selects a charity, makes a donation, the donation is reported and tracked by the system, the system, sometimes called ReQpon, issues discount points or coupons or ReQpons that are received or transferred to the individual.

FIG. 16 depicts an individual using 800 a system coupon within the disclosed ReQpon system 810 and a merchant granting a discount 820 in exchange for the individual's points or coupons.

FIG. 16 can also be viewed as a system wherein an individual uses an app to locate an in network merchant; the individual executes a purchase from said merchant, the merchant receives the individual's money and points, then the merchant may reuse the points or coupons with other in network merchants or otherwise transfer the points.

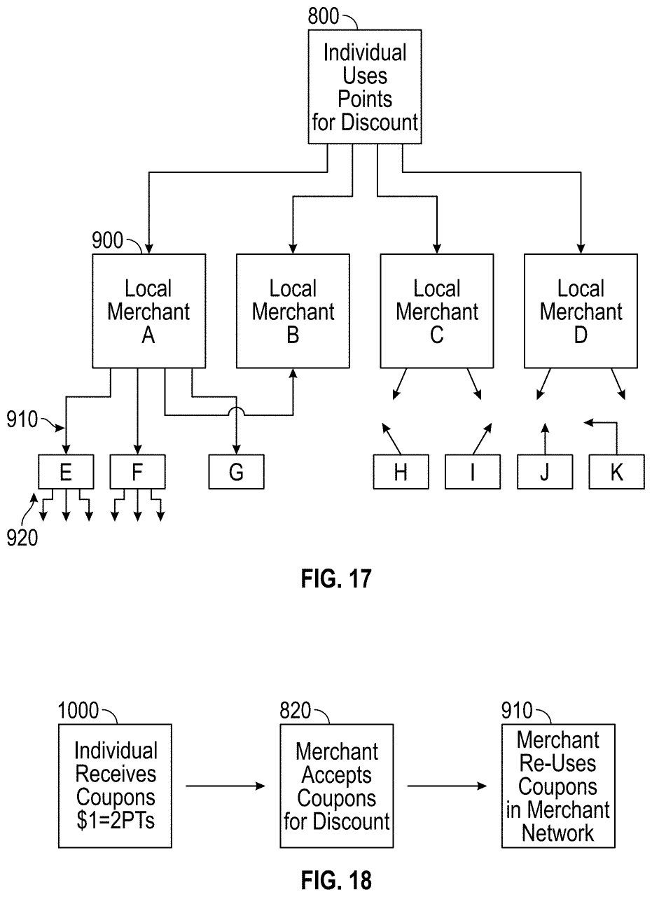

FIG. 17 depicts the reusable nature of the disclosed reusable coupons or ReQpons wherein an individual user 800 uses a coupon or points for a discount from a merchant 900 and then the merchant may reuse 910 a coupon or transfer the coupon to third parties 920 or other downstream recipients.

FIG. 18 depicts an option of a multiplier being used in the acquisition of system, points or coupons. For example, an individual donation of one dollar could be multiplied 100 resulting in two dollars of coupons being issued to the donner/individual. Then a merchant may accept the coupons for a discount 820 and the merchant may reuse 910 the coupons.

What is claimed is:

1. A method to create, reuse and circulate discount coupons or points honored by in-network merchants and created by consumer donations to charities, the method comprising the steps of:
a) a consumer makes a donation to a charitable organization;
b) the consumer receives discount coupons in an amount determined by the size of the donation to the charitable organization;
c) the consumer finds an in-network merchant;
d) the consumer purchases goods or services from the in-network merchant, the consumer paying with money and some portion of the discount coupons or points;
e) the in-network merchant reuses the discount coupons or points that were obtained from the consumer wherein the reused discount coupons or points may be reused again.

2. The method of claim 1 wherein the coupons or points are issued in integer denominations.

3. The method of claim 2 wherein the coupons or points provide a percentage discount on goods or services from in-network merchants.

4. The method of claim 3 wherein the total value of coupons or points used in one transaction is limited to a monetary value.

5. The method of claim 1 wherein the value of the coupons or points issued to a consumer is a multiple of the consumer's donation to the charitable organization.

6. An interface system (600) used to convert charitable donations into discounts with enrolled merchants, the interface system comprising:
a) a consumer home screen interface (610);
b) an initial shopping and point interface (620) comprising a shop icon, a get points icon, a community update icon and a points remaining display;
c) a charity selection interface (630) comprising a plurality of enrolled charities and comprising means to select charities for donations; and
d) an initial donation interface (640) comprising an amount to donate column, a donation multiplier column, a points column and a percentage of donation row, wherein the values of the percentage of donation row are selected upon a percentage of donation interface (650).

7. The interface system of claim 6 further comprising:
a) an initial search for merchants interface (660);
b) a merchant drop down selection interface (670);
c) a merchant attribute interface (675);

8. The interface system of claim 7 further comprising:
a) a price and discount interface (680);
b) a completed transaction interface (685);
c) a post sale communication interface (690).

9. The interface system of claim 8 in communication with a system server (100).

10. The interface and server system of claim 9 in communication with a plurality of databases (200), the plurality of databases comprising a non-profit organizations database (210), registered consumers database (230) and a registered merchant database (230).
